(19) United States
(12) Patent Application Publication
(10) Pub. No.: US 2013/0028229 A1
(43) Pub. Date: Jan. 31, 2013

(54) METHOD FOR CONTROLLING THE APERIODIC TRANSMISSION OF A CONTROL SIGNAL, AND METHOD AND APPARATUS FOR TRANSCEIVING THE CONTROL SIGNAL USING THE SAME

(71) Applicants: Sungjin Suh, Seoul (KR); Sungkwon Hong, Seoul (KR)

(72) Inventors: Sungjin Suh, Seoul (KR); Sungkwon Hong, Seoul (KR)

(73) Assignee: PANTECH CO., LTD., Seoul (KR)

(21) Appl. No.: 13/641,423

(22) PCT Filed: Apr. 14, 2011
(86) PCT No.: PCT/KR2011/002669

§ 371 Date: Oct. 15, 2012

(30) Foreign Application Priority Data
Apr. 14, 2010 (KR) 10-2010-0034066

(51) Int. Cl. H04W 72/04

(52) U.S. Cl. 370/329

(57) ABSTRACT

A method for controlling the aperiodic transmission of a control signal, comprises the following steps: determining a period during which a base station is to transmit an aperiodic control signal; and generating indication information for indicating the determined period, and transmitting the indication information to user equipment.

### CROSS-REFERENCE TO RELATED APPLICATIONS

This application is the National Stage Entry of International Application No. PCT/KR2011/002669, filed on Apr. 14, 2011, and claims priority from and the benefit of Korean Patent Application No. 10-2010-0034066, filed on Apr. 14, 2010, all of which are incorporated herein by reference for all purposes as if fully set forth herein.

### BACKGROUND

1. Field

The present invention relates to a wireless communication system, and particularly, to a method and apparatus for dynamically controlling aperiodic transmission of a control signal for estimating a state of resources in an OFDMA wireless communication system so that an aperiodic control signal is effectively transmitted and received based on a state of a wireless channel and a user equipment.

2. Discussion of the Background

As communication systems have developed, various wireless terminals have been utilized by consumers, such as companies and individuals.

A current mobile communication system, for example, 3GPP, Long Term Evolution (LTE), LTE-Advanced (LTE-A), and the like, may be a high capacity communication system capable of transmitting and receiving various data such as image data, wireless data, and the like, beyond providing a sound-based service. Accordingly, there is a desire for a technology that transmits high capacity data, which is comparable with a wired communication network. Also, the system is required to include an appropriate error detection scheme that minimizes loss of information and increases transmission efficiency of the system so as to enhance performance of the system.

Also, varied control signals have been utilized in current various communication systems to provide information associated with a communication environment and the like, to a counterpart apparatus through an uplink or a downlink, and an example of the control signal may be a reference signal (RS).

For example, an LTE system, which is one of the mobile communication methods, transmits, to a base station, a sounding reference signal (SRS) as a channel estimation reference signal indicating a channel state of a user equipment (hereinafter referred to as a ‘UE’ or a ‘user equipment’) during uplink transmission, and transmits a reference signal or a cell-specific reference signal (CRS) at every subframe to recognize channel information during downlink transmission.

In general, the reference signals for channel estimation and the like may be periodically generated by a reference signal transmitting apparatus, that is, a UE in the case where the reference signal corresponds to an uplink reference signal, and a BS in the case where the reference signal corresponds to a downlink reference signal, and may be transmitted to a reference signal receiving apparatus.

Although aperiodic transmission of a channel estimation reference signal and the like has been discussed in consideration of a flexibility of a communication system and the like, a detailed scheme thereof has not yet been determined.

### SUMMARY

Therefore, the present invention has been made in view of the above-mentioned problems, and an aspect of the present invention is to provide a scheme of transmitting a control signal based on a periodic transmission scheme and an aperiodic transmission scheme when a user equipment transmits a control signal in a communication system, and to provide a technique that generates minimum interference to users in the same cell or a neighbor cell while operating the transmission.

Another aspect of the present invention is to provide a technique that transmits a control signal by being in balance with existing groups that periodically transmit signals and minimizing interference since there is a high probability of causing interference to another group when a group aperiodically transmits a control signal in a communication system that is set to periodically transmit a control signal base on a different scheme for each cell.

Another aspect of the present invention is to provide a method and apparatus for controlling transmission of a control signal so that interference to a user equipment in the same cell or a neighbor cell may be reduced and transmission of a control signal is controlled in real time and thus, transmission and reception of a control signal may be dynamically controlled based on a state of a user equipment and a network.

In accordance with an aspect of the present invention, there is provided a method for a base station to control aperiodic transmission of a control signal of a user equipment, the method including: determining a period in which the user equipment is to transmit an aperiodic control signal; generating one or more pieces of period indication information indicating a time length of the period in which the aperiodic control signal is to be transmitted and one or more pieces of end indication information; generating indication information including the period indication information and the end indication information, and transmitting the indication information to the user equipment; and receiving the aperiodic control signal from the user equipment during the determined period.

In accordance with another aspect of the present invention, there is provided a method of transmitting an aperiodic control signal, the method including: receiving, from a base station, indication information indicating a time length of a transmission period of an aperiodic control signal; extracting, from the indication information, one or more pieces of period indication information and at most one piece of end indication information; determining the transmission period of the aperiodic control signal by calculating the time length of the period based on the one or more pieces of period indication information; and transmitting, to the base station, the aperiodic control signal in the determined transmission period.

In accordance with another aspect of the present invention, there is provided an apparatus for transmitting indication information for aperiodic transmission of a control signal, the apparatus including: an indication information generating unit to determine a period in which an aperiodic control signal is to be transmitted, and to generate indication information including one or more pieces of period indication information indicating a time length of the determined period and one or more pieces of end indication information; a coding unit to generate a wireless signal including the indication information; and a transceiving unit to transmit the wireless signal to a user equipment and to receive the aperiodic control signal during the determined period.

In accordance with another aspect of the present invention, there is provided an apparatus for transmitting an aperiodic control signal, the apparatus including: a transceiving unit to receive, from a base station, a wireless signal including indication information indicating a transmission period of an aperiodic control signal, and to transmit a channel estimation signal to the base station; an indication information extracting unit to extract the indication information from the wireless signal, and to extract one or more pieces of period indication information and at most one piece of end indication information from the indication information; and a control signal generating unit to calculate a time length of the period in which an aperiodic control signal is to be transmitted based on the one or more pieces of period indication information, and to generate an aperiodic control signal to be transmitted during the period.

### BRIEF DESCRIPTION OF THE DRAWINGS

FIG. 1 is a diagram illustrating a wireless communication system according to embodiments of the present invention;

FIG. 2 is a diagram illustrating a structure of a subframe and a time-slot of transmission data according to an embodiment of the present invention;

FIG. 3 is a diagram illustrating an example of periodic SRS transmission in a communication system according to an embodiment of the present invention;

FIG. 4 is a diagram illustrating various examples of aperiodic SRS transmission;

FIG. 5 is a diagram illustrating various embodiments of a burst SRS which is one of the embodiments of an aperiodic SRS according to embodiments of the present invention;

FIG. 6 is a diagram illustrating a process in which a base station transmits indication information associated with transmission of an aperiodic control signal to a user equipment according to an embodiment of the present invention;

FIG. 7 is a diagram illustrating a process in which a user equipment transmits an aperiodic control signal according to an embodiment of the present invention;

FIG. 8 is a diagram illustrating an example of performing a 2-bit signaling according to an embodiment of the present invention;

FIG. 9 is a diagram illustrating an example of performing a 2-bit signaling according to another embodiment of the present invention;

FIG. 10 is a diagram illustrating an example of performing a 1-bit signaling according to an embodiment of the present invention;

FIG. 11 is a diagram illustrating a configuration of an apparatus for transmitting indication information for aperiodic transmission of a control signal according to an embodiment of the present invention; and

FIG. 12 is a diagram illustrating a configuration of an apparatus for transmitting an aperiodic control signal according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

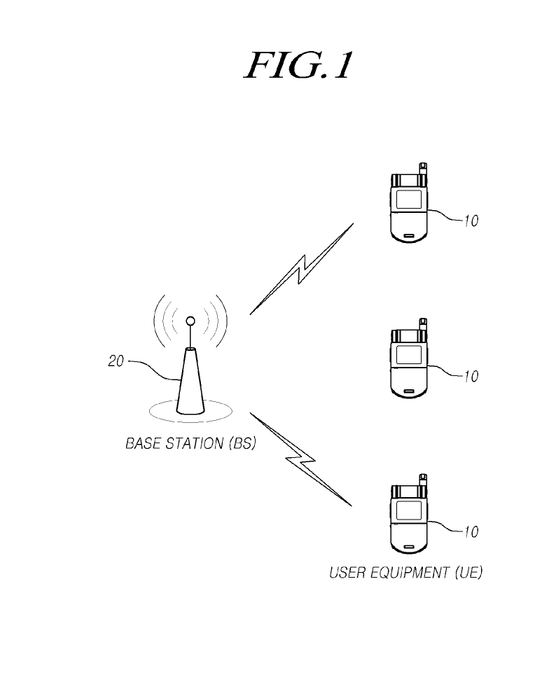

FIG. 1 illustrates a wireless communication system according to embodiments of the present invention.

The wireless communication system may be widely installed so as to provide various communication services, such as a voice service, packet data, and the like.

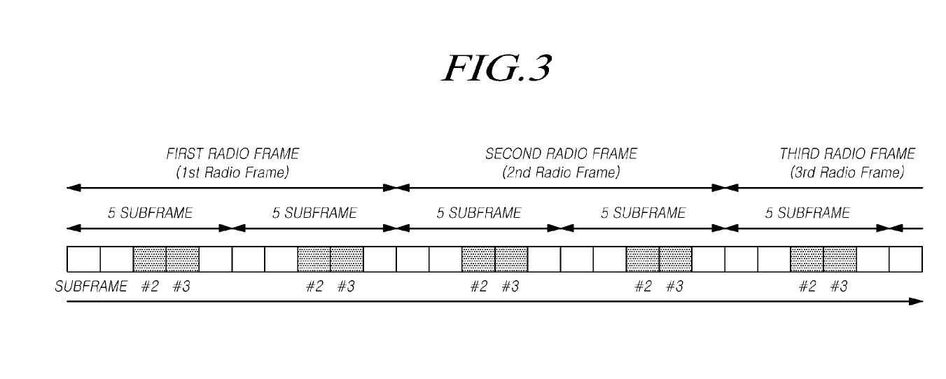

Referring to FIG. 1, the wireless communication system may include a user equipment (UE) 10 and a base station (BS, eNB) 20. A technique of generating a reference signal for expanded channel estimation according to embodiments of the present invention to be described in below may be applied to the user equipment 10 and the base station 20, which will be described in detail from FIG. 3.

Throughout the specifications, the user equipment 10 may be an inclusive concept indicating a user terminal utilized in wireless communication, including a UE in WCDMA, LTE, HSPA, and the like, and a mobile station (MS), a user terminal (UT), a subscriber station (SS), a wireless device, and the like in GSM. Hereinafter, a user equipment, a user terminal, and a UE is may be directed to the same meaning.

In general, the base station 20 or a cell may refer to all devices, a function, or a predetermined area where communication with the user equipment 10 is performed, and may also be referred to as a Node-B, an evolved Node-B (eNB), a sector, a site, a Base Transceiver System (BTS), an access point, a relay node, and the like.

That is, the base station 20 or the cell may be construed as an inclusive concept indicating a portion of an area or a function covered by a NodeB in WCDMA, an eNB or a sector (site) in LTE, and the like, and the concept may include various coverage areas, such as a megacell, a macrocell, a microcell, a picocell, a femtocell, a communication range of a relay node, and the like.

In the specifications, the user equipment 10 and the base station 20 are used as two inclusive transceiving subjects to embody the technology and technical concepts described in the specifications, and may not be limited to a predetermined term or word.

The wireless communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

Uplink transmission and downlink transmission may be performed based on a Time Division Duplex (TDD) scheme that performs transmission based on different times, or based on a Frequency Division Duplex (FDD) scheme that performs transmission based on different frequencies.

An embodiment of the present invention may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. Embodiments of the present invention may not be limited to a specific wireless communication scheme, and may be applicable to all technical fields to which a technical idea of the present invention is applicable.

The wireless communication system may support an uplink and/or downlink HARQ, and may use a channel quality indicator (CQI) for link adaptation. Also, a multiple access scheme for downlink transmission and a multiple access scheme for uplink transmission may be different from each other. For example, a downlink may use Orthogonal Frequency Division Multiple Access (OFMDA) and an uplink may use Single Carrier-Frequency Division Multiple Access (SC-FDMA).

Layers of a radio interface protocol between a user equipment and a network may be distinguished as a first layer (L1), a second layer (L2), and a third layer (L3), based on three lower layers of a well-known Open System Interconnection (OSI) model in a communication system, and a physical layer of the first layer may provide an information transfer service through use of a physical channel.

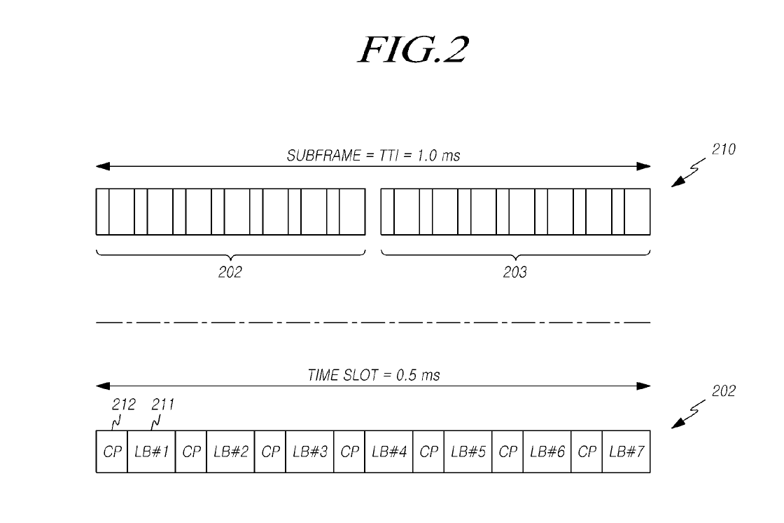

FIG. 2 illustrates a structure of a subframe and a time-slot of transmission data according to an embodiment of the present invention.

Referring to FIG. 2, a single radio frame or a wireless frame may be formed of 10 subframes 210, and a single subframe may include two slots 202 and 203. A basic unit for data transmission may be a subframe, and uplink scheduling or downlink scheduling may be performed based on a subframe unit. A single slot may include a plurality of OFDM symbols in a time domain, and may include at least one subcarrier in a frequency domain (frequency band), and a single slot may include 7 or 6 OFDM symbols.

For example, when a subframe is formed of two time-slots, each time-slot includes 7 symbols in a time domain and 12 subcarriers in a frequency domain. Although a time-frequency domain defined by a single slot as described in the foregoing may be referred to as a resource block (RB), it may not be limited thereto.

In 3GPP LTE system, a transmission time of a frame is divided into a transmission time interval (TTI) having a duration of 1.0 ms. “TTI” and “subframe” may be directed to the same meaning, and a frame having a length of 10 ms may include 10 TTIs.

The diagram 202 illustrates a general structure of a time-slot according to an embodiment of the present invention. As described in the foregoing, the TTI may be a basic transmission unit, and a single TTI may include two time-slots 202 and 203 of the same length and each time-slot has a duration of 0.5 ms. The time-slot may include seven long blocks (LB) 211 associated with symbols. The LBs may be separated by cyclic prefixes (CPs) 212. Although a single TTI or a subframe may include 14 LB symbols, embodiments of the present invention may not be limited to the structure of the frame, the subframe, or the time-slot structure as described in the foregoing.

In an LTE communication system, which is one of the current wireless communication schemes, a demodulation reference signal (DMRS) and a sounding reference signal (hereinafter referred to as ‘SRS’ or ‘sounding reference signal’) are defined for an uplink, and three reference signals, that is, a cell-specific reference signal (CRS), a multicast/broadcast over single frequency network reference signal (MBSFN-RS), and a UE-specific reference signal, are defined for a downlink.

That is, a user equipment in the wireless communication system may transmit, to a base station, an uplink channel estimation reference signal which is one of the reference signals, so as to transfer uplink channel information to the base station.

An example of the channel estimation reference signal may include a sounding reference signal that is used in LTE and LTE-Advanced, and the channel estimation reference signal may function as a pilot channel with respect to an uplink channel.

In the specifications, embodiments of the present invention will be described based on a sounding reference signal (SRS) which is an example of the channel estimation reference signal, but the embodiments of the present invention may not be limited to the SRS or the channel estimation reference signal and may include all types of control signals used in an uplink or a downlink.

The SRS may need to transfer uplink channel information associated with all bands including a band to be used by each UE and a band having a probability of being used by each UE. That is, the SRS may need to be transmitted over the entire subcarrier band.

According to the current LTE standard, an SRS sequence may be generated based on Equation 1, and the generated SRS sequence may go through resource mapping based on a predetermined criterion and may be transmitted based on a subframe setting as shown in Table 1.

r^{SRS}(n)=r_{u,v}^{(60 )}(n)=e^{janr} r̅_{u,v}(n), 0≦n≦M_{SC}^{RS} [Equation 1]

Here, M_{SC}^{RS}=mN_{SC}^{RB} denotes a length of a reference signal sequence, and 1≦m≦N_{RB}^{max,UL}. u denotes a PUCCH sequence group number, v denotes a base sequence number, and a cyclic shift (CS)

$$α = 2 π \frac{{n}_{SRS}^{cs}}{8} .$$

n_{SRS}^{CS} may be an integer to value in a range from 0 through 7, and may be set for each UE by a upper layer.

TABLE 1

| | | Configuration | Transmission |
|---|---|---|---|
| | | Period T_{SFC} | offset Δ_{SFC} |
| srsSubframeConfiguration | Binary | (subframes) | (subframes) |
| 0 | 0000 | 1 | {0} |
| 1 | 0001 | 2 | {0} |
| 2 | 0010 | 2 | {1} |
| 3 | 0011 | 5 | {0} |
| 4 | 0100 | 5 | {1} |
| 5 | 0101 | 5 | {2} |
| 6 | 0110 | 5 | {3} |
| 7 | 0111 | 5 | {0, 1} |
| 8 | 1000 | 5 | {2, 3} |
| 9 | 1001 | 10 | {0} |
| 10 | 1010 | 10 | {1} |
| 11 | 1011 | 10 | {2} |
| 12 | 1100 | 10 | {3} |
| 13 | 1101 | 10 | {0, 1, 2, 3, 4, |
| | | | 6, 8} |
| 14 | 1110 | 10 | {0, 1, 2, 3, 4, |
| | | | 5, 6, 8} |
| 15 | 1111 | Inf | N/A |

Table 1 may be a subframe setting table of an FDD sounding reference signal, defined in LTE. Each srsSubframeConfiguration may be defined by 4 bits, and a transmission period and an offset of a transmission subframe may be defined for each case.

That is, when a value of srsSubframeConfiguration is 8 (1000 in the binary system), an SRS may be transmitted at second and third subframes in every five subframes.

FIG. 3 illustrates an example of periodic SRS transmission in a communication system according to an embodiment of the present invention. For example, when a value of srsSubframeConfiguration is 8 (1000 in the binary system), an SRS may be transmitted at second and third subframes in every five subframes. Also, the SRS may be transmitted at the last symbol of each subframe, but it may not be limited thereto.

According to the SRS setting as shown in Table 1 and FIG. 3, an SRS may be periodically transmitted at each radio frame or each transmission period, for each cell (base station).

In a case where srcSubframeConfiguration is 8 of Table 1, a configuration period is 5 subframes, and a transmission offset corresponds to 2 and 3. FIG. 3 illustrates a case that transmits an SRS at a subframe #2 and a subframe #3 in every five subframes.

| | | Configuration Period | Transmission |
|---|---|---|---|
| | | T_{SFC} | offset Δ_{SFC} |
| srsSubframeConfiguntion | Binary | (subframes) | (subframes) |
| 8 | 1000 | 5 | {2, 3} |

However, as a communication system has advanced, a number of antennas increases, such as a multi input multi output (MIMO), and a communication system, such as a Cooperative MultiPoint Tx/Rx System (CoMP) and the like, that requires transmission and reception of a reference signal with a neighbor cell in addition to a serving cell that mainly performs transmission and reception with a corresponding user has been introduced. Therefore, the periodic SRS transmission scheme may have difficulty in obtaining a sufficient SRS capacitor. Accordingly, expansion of the SRS capacitor may be required. That is, it has been discussed that scheduling flexibility of an SRS needs to be increased by adjusting an SRS which is transmitted periodically to be transmitted aperiodically, so as to improve the SRS capacitor.

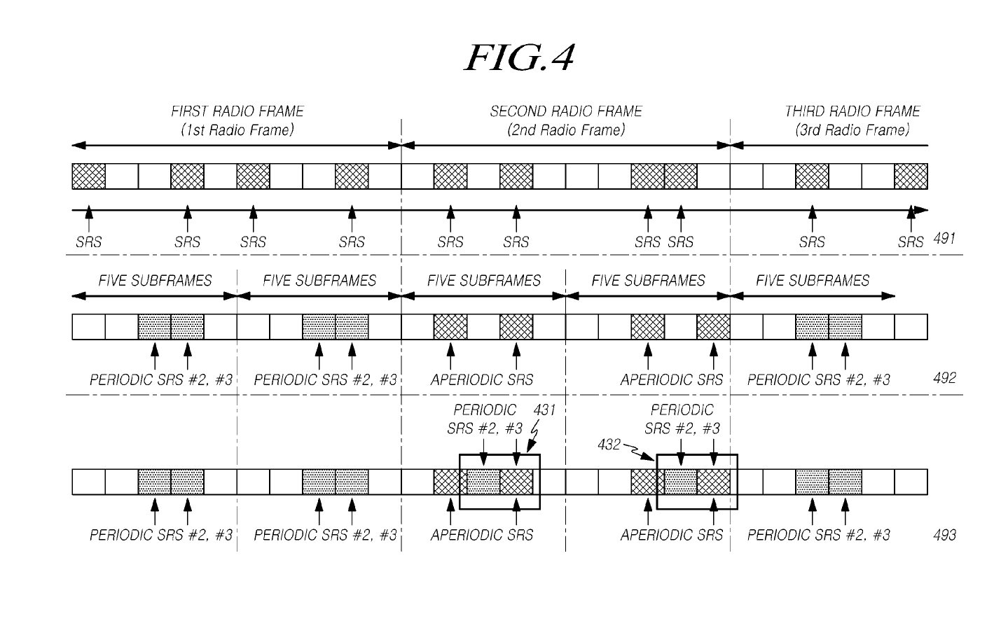

An example of adjusting an SRS to be transmitted aperiodically may be as follows. FIG. 4 is a diagram illustrating an example of aperiodic SRS transmission, and illustrates an example of aperiodic SRS transmission, an example of transmitting an aperiodic SRS and a periodic SRS together, and an example of switching a periodic SRS and an aperiodic SRS.

The diagram 491 of FIG. 4 illustrates a subframe in which an SRS signal is aperiodically transmitted within a single radio frame, and a periodic SRS is not transmitted, other than an aperiodic SRS.

The diagram 492 illustrates an example in which aperiodic SRS transmission and periodic SRS transmission are performed together. For example, an SRS may be periodically transmitted at a first period and a second period corresponding to a first radio frame, using 5 subframes as a single period. An SRS may be aperiodically transmitted at a third period and a fourth period corresponding to a second radio frame, and an SRS may be periodically transmitted again at a fifth period corresponding to a third radio frame.

However, a problem may occur when the aperiodic SRS and the periodic SRS are switched as shown in the diagram 493. That is, as illustrated in the diagrams 431 and 432, there may be a problem in that an existing periodic SRS of another UE is transmitted as it is, in addition to an aperiodic SRS. Unlike the diagram 493, although not illustrated, a periodic SRS needs to be transmitted after aperiodic SRS transmission is completed, but a periodic SRS is not transmitted and a corresponding frequency resource may be wasted since a switching time does not match.

That is, a time for the periodic SRS transmission and a time for the aperiodic SRS transmission overlap each other, or periodic/aperiodic SRS transmission is not performed at all.

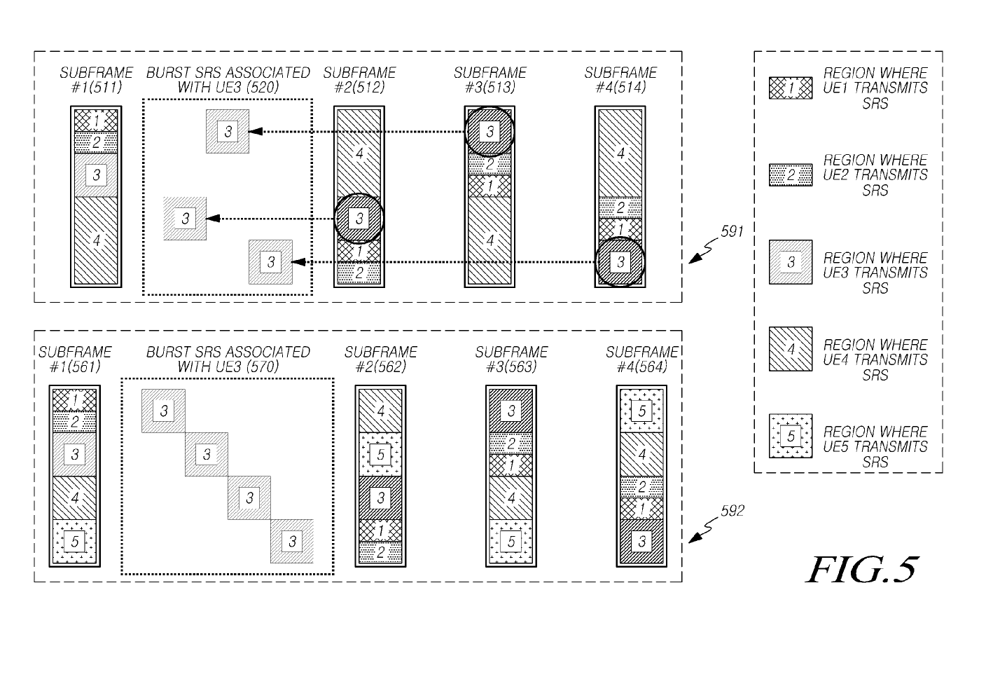

FIG. 5 illustrates an embodiment of a burst SRS which is one of the embodiments of an aperiodic SRS according to embodiments of the present invention. In the diagram 591, a burst SRS may correspond to a scheme that maintains a frequency band allocated to a corresponding UE, and transmits an SRS multiple times. That is, a location of a frequency domain that is previously allocated for a UE3 to transmit an SRS may be located for each subframe, that is, each of subframes 511, 512, 513, and 514. When the UE3 receives, from a base station, a signal instructing transmission of a burst SRS, the UE3 may transmit an aperiodic SRS within a frequency band originally allocated to the UE3, as illustrated in the diagram 520. In the diagram 520, SRS transmission is performed at one burst and thus, a time expended for sounding an entire bandwidth may be reduced.

In the diagram 591, a burst SRS may be transmitted through use of a frequency band associated with periodic SRS transmission, allocated to the UE3 in the subframe #2 512, the subframe #3 513, and the subframe #4 514. That is, a corresponding resource may be transmitted sequentially according to a configuration of an existing periodic SRS, in the order of i) a bandwidth allocated in the subframe #2 512, ii) a bandwidth allocated in the subframe #3 513, and iii) a bandwidth allocated in the subframe #3 513, at one burst. Unlike the scheme 520 of the diagram 591 that is based on the configuration of the existing periodic SRS, burst transmission may be performed based on another predetermined scheme, which will be described with reference to a scheme 570 of the diagram 592.

Unlike the diagram 591, the diagram 592 illustrates burst SRS transmission that is not based on a configuration of a periodic SRS. As one of the schemes that are not based on the configuration of the periodic SRS, a scheme that divides a frequency band of an entire frequency domain and sequentially performs sounding, may be used. That is, SRSs may be sequentially transmitted to perform sounding in the entire frequency band as illustrated in the scheme 570, irrespectively of frequency bands allocated to the UE3 in a subframe #2 562, a subframe 33 563, and a subframe #4 564. Also, the aperiodic burst SRS transmission may be performed inversely or based on a pre-defined scheme, in addition to the scheme 570.

When the aperiodic burst SRS transmission is performed as described in the diagram 591 or the diagram 592 of FIG. 5, information associated with a duration set for the is burst transmission or a period set for the burst transmission may be transferred to a user equipment through an upper layer signaling. However, to transmit the information, a large amount of bits may be required.

In the case of aperiodic burst SRS transmission of FIG. 5, a duration in which burst transmission is performed or a period parameter may be transferred through the upper layer signaling. For example, in the case of a time associated with aperiodic SRS transmission, there may be various cases such as SRS transmission of 5 consecutive times, or SRS transmission of 10, 15, or 20 consecutive times, which requires a large amount of bits. Therefore, a large amount of overhead may be created when the varied information is transmitted through a lower layer signaling such as a PDCCH and the like and thus, the information may be transmitted through the upper layer signaling, such as a scheme of transmitting a parameter of an existing periodic SRS. However, in terms of a processing speed, the upper layer signaling may expand a time at least 15 times greater than the lower layer signaling and thus, may have difficulty in scheduling aperiodic SRS transmission that requires dynamic transmission in a short period of time.

The embodiments of the present invention provides a method of scheduling aperiodic SRS transmission so as to quickly and dynamically control signal transmission by receiving a plurality of sequential lower layer signals and extracting required information.

Hereinafter, the embodiments of the present invention will be described based on a channel estimation reference signal as an embodiment of a control signal including an SRS, DMRS, and the like which have been described in the foregoing. However, the embodiments of the present invention may not be limited to the channel estimation reference signal, and may be applicable to all control signals that are transmitted or received so as to estimate a channel between a base station and a user equipment, to transfer information associated with modulation, or to share state information of a network and the like.

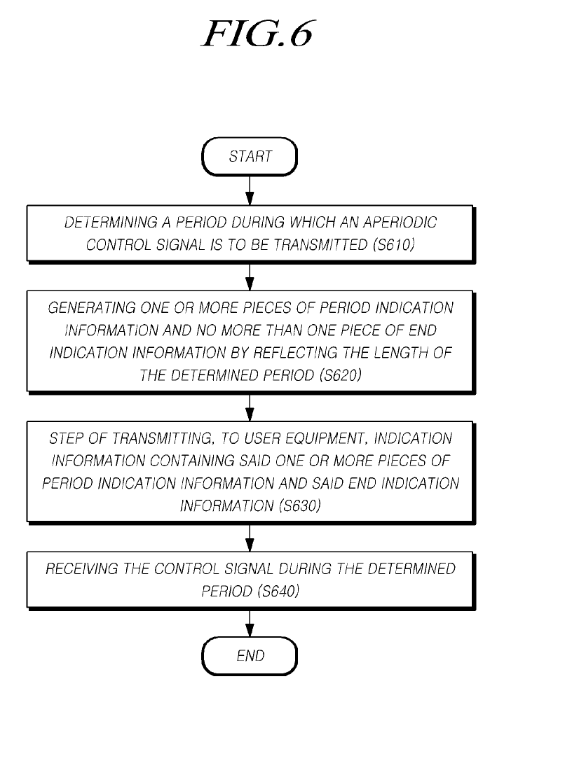

FIG. 6 is a diagram illustrating a process in which a base station transmits indication information associated with transmission of an aperiodic control signal to a user equipment according to an embodiment of the present invention.

The base station may determine a period in which an aperiodic control signal is to be transmitted, so as to control aperiodic transmission of a reference signal of the user equipment (step S610). An embodiment of the period in which the aperiodic control signal is transmitted may include a period in which an aperiodic channel estimation reference signal is transmitted. For example, when the base station determines a predetermined user equipment to aperiodically transmit an SRS, which is a control signal, based on a burst scheme, the base station may determine a subframe duration in which the user equipment is to transmit a burst SRS.

The base station may generate indication information indicating the determined period, and transmit the indication information to the user equipment. In particular, the indication information may be a length of the period in which the periodic control signal is to be transmitted, for example, time information associated with the aperiodic control signal transmission. Therefore, according to an embodiment of the present invention, to transmit the indication information indicating the determined period, one or more pieces of period indication information and at most one piece of end indication information based on the length of the determined period (step S620). In particular, the indication information may include N pieces of period indication information, and N bits obtained by extracting 1 bit from each of the N pieces of period indication information and combining the extracted bits may be information required for calculating the length of the period.

According to an embodiment of the present invention, one or more pieces of period indication information may be combined so as to indicate the length of the period. In this process, the length of the period may be determined by extracting a portion of each of the one or more pieces of period indication information (for example, 1 bit) and by combining the extracted portions. According to an embodiment of the present invention, the end indication information may be indication information informing the user equipment that transmission of the period indication information is completed.

For example, the indication information may be formed as given in Table 2.

TABLE 2

| 2-bit signaling | Action |
|---|---|
| 00 | Not recognize bit information |
| 01 | Reserved |
| 10 | Recognize as “0” bit |
| 11 | Recognize as “1” bit |

‘10’ and ‘11’ may be embodiments of the period indication information, and ‘00’ may be an embodiment of the end indication information. A second bit of the period indication is information may be used as length information of an aperiodic control signal, through combining. For example, it may be used as length information of a period in which an SRS is to be aperiodically transmitted.

A first bit in the 2 bits may be an indicator which determines whether information of a second bit is to be used as control information. That is, when the first bit is ‘1’, the second bit may be recognized as information required for aperiodic SRS transmission. In particular, to instruct a predetermined user equipment to transmit an aperiodic SRS during a predetermined period of time, the base station may calculate an interval of a subframe in which an aperiodic SRS is to be transmitted so as to calculate a bit to indicate the interval of the corresponding subframe. For example, when aperiodic SRS transmission is instructed to be performed during 6 subframes, 6 may be expressed as ‘110’ based on the binary system. When the ‘110’ is applied to the 2 bits as illustrated in Table 2, ‘110’ is three bits and thus, three pieces of period indication information may be used. 1 which corresponds to a first bit and a second bit may be expressed as ‘11’ and ‘0’ which corresponds to the last bit may be expressed as ‘10’. Therefore, to instruct aperiodic SRS transmission during the 6 subframes, three pieces of period indication information, that is, ‘11’, ‘11’, and ‘10’, may be used. To stop the user equipment from interpreting a bit, ‘00’ corresponding to the end indication information may be sequentially transmitted.

Table 2 indicates a structure that sequentially transmits a plurality of sequential control signals. According to an embodiment of the present invention, bit information transmitted through a PDCCH may be received by a UE based on 1 ms. Therefore, aperiodic SRS transmission may be dynamically controlled, and may be sufficiently appropriate for a network condition. At most one piece of end indication information may be generated since the indication information may be formed of only the period indication information without the end indication information.

The base station may transmit the indication information including the one or more pieces of period indication information and the end indication information (step S630). At most one piece of end indication information may be generated and thus, the end indication information may not be transmitted. In particular, the period indication information and the end indication information may be sequentially transmitted. That is, the period indication information or the end indication information may be included in a PDCCH for transmission, or may be transmitted for each subframe.

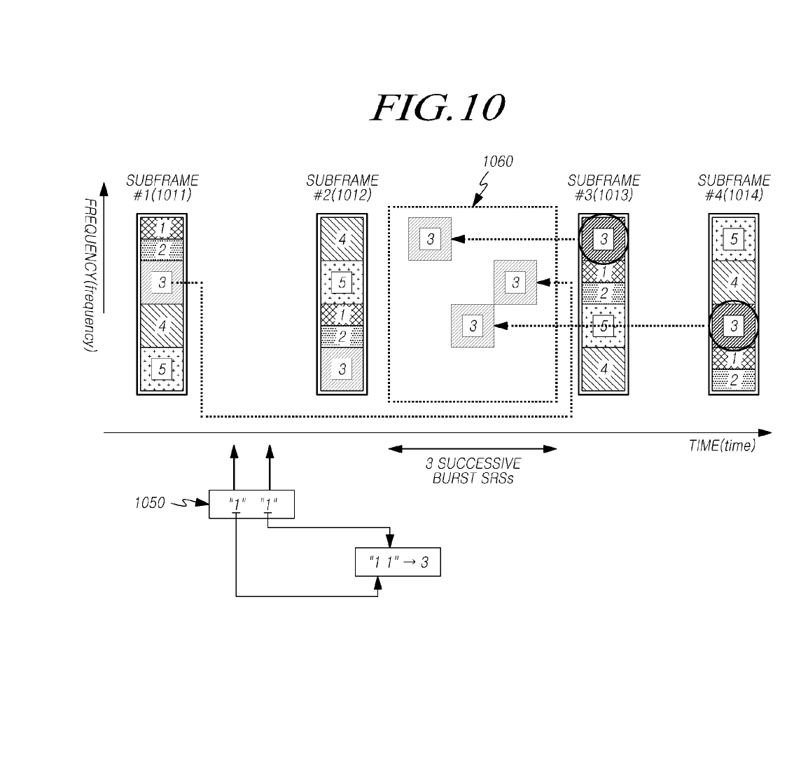

According to another embodiment of the present invention, the end indication information may be excluded. For example, FIG. 10 and Table 3 may control aperiodic control signal transmission of a user equipment through use of only the period indication information without using the end indication information.

Subsequently, the base station transmits the indication information, and receives, from the user equipment that receives the indication information, a control signal during a length of a period corresponding to the transmitted indication information (step S640). An embodiment of receiving a control signal may include receiving an SRS from the user equipment, and the control signal may include a reference signal that is capable of estimating a channel such as a DM-RS in addition to the SRS.

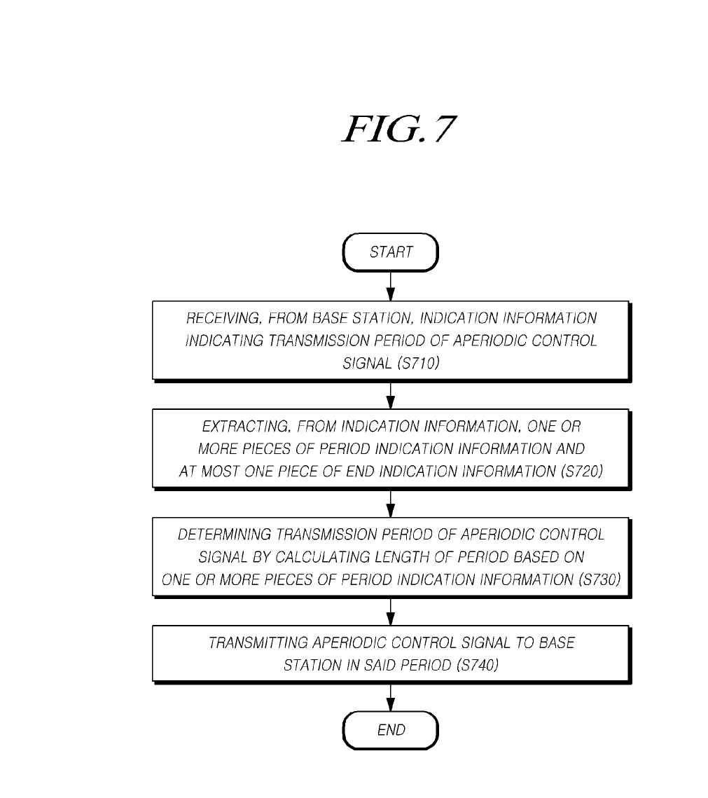

FIG. 7 is a diagram illustrating a process in which a user equipment transmits an aperiodic control signal according to an embodiment of the present invention.

In FIG. 7, the user equipment may receive, from a base station, indication information indicating a transmission period of an aperiodic control signal, may determine a period in which the aperiodic control signal is to be transmitted based on the received indication information, and may transmit the aperiodic control signal to the base station during the corresponding period.

The process will be described in detail as follows.

The user equipment may receive the indication information indicating the transmission period of the aperiodic control signal from the base station (step S710). The indication information may indicate a length of the period in which the aperiodic control signal is to be transmitted. In particular, an embodiment of the transmission period of the aperiodic control signal may include a transmission period in which a channel estimation reference signal is to be aperiodically transmitted. As described in FIG. 6, a time period in which an aperiodic control signal is transmitted such as a length of a subframe, a unit associated with the time period, or the like may be included. Also, the indication information may be formed of period indication information and end indication information as described in FIG. 6 and Table 2. Also, the indication information may be formed of only the period indication information, which will be described with reference to Table 3 and FIG. 10.

Accordingly, the reception process of step S710 may include sequentially receiving the period indication information and the end indication information. In particular, the period indication information or the end indication information included in a PDCCH may be received, or the indication information may be transmitted for each subframe.

The user equipment may determine a period in which the aperiodic control signal is to be transmitted based on the indication information. In particular, the user equipment may extract one or more pieces of period indication information and at most one piece of end indication information from the indication information (step S720). An embodiment of the period indication information and the end indication information has been provided in FIG. 6 and Table 2. A case that transmits only the period indication information will be described in detail with reference to FIG. 10 and Table 3. At most one piece of end indication information may be extracted. This may include a case that extracts only the period indication information from the indication information. In Table 3, end indication information may not exist separately.

The transmission period of the aperiodic control signal may be determined by calculating a length of the period based on the one or more pieces of period indication information (step S730). In particular, the length of the period may be calculated based on N bits obtained by extracting 1 bit from each of N pieces of period indication information included in the indication information, and combining the extracted bits. The calculation process has been described in FIG. 6 and Table 2.

The transmission period may include a period in which the user equipment transmits the aperiodic control signal, as described in the foregoing. In the period, the user equipment may transmit the aperiodic control signal to the base station (step S740).

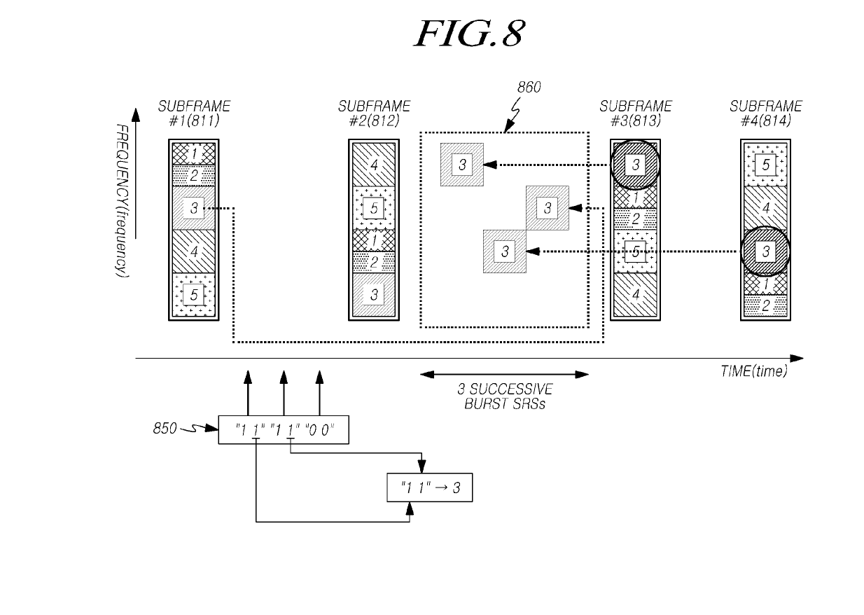

FIG. 8 is a diagram illustrating an example of performing a 2-bit signaling according to an embodiment of the present invention.

FIG. 8 illustrates a process of transmitting an aperiodic control signal. Although an SRS is provided as an embodiment of the aperiodic control signal, FIG. 8 may be applied to aperiodic transmission of all control signals. An eNB may indicate a transmission period of an aperiodic SRS by applying a 2-bit signaling of Table 2, and a user equipment transmits an aperiodic SRS according to the signaling.

FIG. 8 illustrates a scheme that receives information shown in Table 2, and transmits an aperiodic SRS.

Periodic SRS transmission is scheduled in subframes #1 through #4 811, 812, 813, and 814. The subframes #1 through #4 811, 812, 813, and 814 may not be consecutive subframes, and may include another subframe among them in terms of a time.

A UE3, which is a user equipment, may receive information associated with aperiodic SRS transmission as illustrated in the diagram 850. The UE3 may receive ‘11’, ‘11’, and ‘00’ based on a 2-bit unit, which are two pieces of period indication information (‘11’ and ‘11’) and a piece of end indication information (‘00’). That is, when a first bit of each of the received 2-bit information is 1, a following bit may be determined to be information associated with aperiodic SRS transmission, and interpretation may be performed. In the diagram 850, when second bits of ‘11’ and ‘11’ corresponding to the period indication information that are received before ‘00’ corresponding to the end indication information is received are combined, ‘11’ may be obtained and ‘11’ may be calculated to be 3 based on the decimal system. The UE3 may interpret the information as burst SRS transmission of 3 consecutive times, and may successively transmit an SRS 3 times. In this example, a frequency band in which an SRS is transmitted may be based on a scheme determined in a periodic SRS scheduling configuration as described in the diagram 591 of FIG. 5, or may proceed with transmission based on another pre-defined scheme as described in the diagram 592 of FIG. 5. In FIG. 8, the UE3 may transmit, at one burst, an SRS in a frequency domain used by the UE3 in a subframe #3 813 and a subframe #4 814 according to a configuration of a periodic SRS as illustrated in the diagram 860. Also, an SRS may be transmitted in the region equal to a frequency domain used by the UE3 in the subframe #1 811, based on the repetitive periodic scheduling after the subframe #4 814.

When the scheme of FIG. 8 is applied, the base station may dynamically control an aperiodic SRS of the user equipment. That is, the base station may control a subframe transmission period, for example, based on an interval of 1 ms in the case of LTE, by taking into consideration a network condition, requirements of the user equipment, and the like and thus, real-time controlling may be possible.

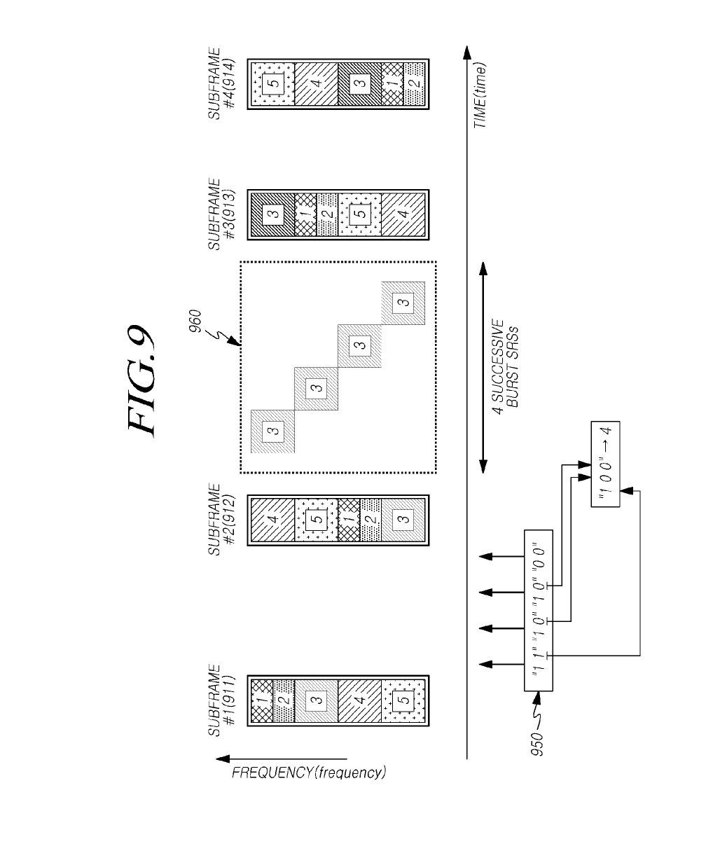

FIG. 9 is a diagram illustrating an example of performing a 2-bit signaling according to another embodiment of the present invention. FIG. 9 also illustrates a process of transmitting an aperiodic control signal. Although an SRS is provided as an embodiment of the aperiodic control signal, FIG. 8 may be applied to aperiodic transmission of all control signals.

FIG. 9 illustrates an example of transmitting 4 successive burst SRSs, unlike FIG. 8, and shows a process of sequentially transmitting a burst SRS in a frequency band based on a pre-defined scheme as illustrated in the diagram 592 of FIG. 5.

A UE3, which is a user equipment, may receive information associated with aperiodic SRS transmission as illustrated in the diagram 950. The UE3 may receive ‘11’, ‘10’, ‘10’, and ‘00’ based on a 2-bit unit. When a first bit in each of the received 2-bit information is 1, a following bit may be determined to be information associated with aperiodic SRS transmission, and interpretation may be performed. In the diagram 950, when second bits of ‘11’, ‘10’, ‘10’ corresponding to the period indication information that are received before ‘00’ corresponding to the end indication information is received are combined, ‘100’ may be obtained and ‘100’ may be calculated to be 4 based on the decimal system. The UE3 may interpret the information as burst SRS transmission of 4 consecutive times, and may successively transmit an SRS 4 times. In this example, a frequency band in which an SRS is transmitted may be based on a scheme determined in a periodic SRS scheduling configuration as described in the diagram 591 of FIG. 5, or may proceed with transmission based on another pre-defined scheme as described in the diagram 592 of FIG. 5. In FIG. 9, the UE3 may sequentially transmit, at one burst, an SRS within a bandwidth of a frequency domain used by the UE3 according to a predetermined order as illustrated in the diagram 960 of FIG. 9.

To perform signaling, Table 3 may be applied according to another embodiment of the present invention.

TABLE 3

| 1-bit signaling | Action |
|---|---|
| 0 | Recognize as “0” bit |
| 1 | Recognize as “1” bit |

Table 3 is another example for a signaling. This may correspond to an example that does not require an indicator in Table 2. In the case of the DCI format 3/3A in the current LTE, when a power control information bit is simultaneously transmitted to a plurality of user equipments through use of transmit power control command radio network temporary identifier (TPC-RNTI) for each group, a common search space may be used, but there may be a format that is capable of transferring power control information only to a user equipment that requires the information. When the similar format is used, information of 1 bit may be transferred to a desired user equipment without separately using an indicator.

In particular, the DCI format 3 may be formed of 2 bits, and may be used to transmit a TPC command associated with a PUCCH and a PUSCH. The DCI format 3A may be formed of 1 bit, and may be used to transmit a TPC command to control power associated with a PUCCH and a PUSCH. The indication information of Table 2 or Table 3 may be included in a PDCCH corresponding to the DCI format3/3A.

FIG. 10 is a diagram illustrating an example of performing a 1-bit signaling according to an embodiment of the present invention. In FIG. 10, a period in which a burst SRS is to be transmitted may be calculated by sequentially performing interpretation based on a 1-bit unit without separately using indication information as illustrated in Table 3. When compared to the 2-bit signaling, an amount of information through a PDCCH may be reduced, and accordingly, an amount of time expended may be reduced.

A UE3 may receive ‘1’ and ‘1’ based on a 1-bit unit as illustrated in the diagram 1050. ‘11’ may be obtained by combining the received information, which indicate 3. Accordingly, the UE3 may successively transmit a burst SRS in 3 subframes as illustrated in the diagram 1060. In this example, a frequency band in which an SRS is transmitted may be based on a scheme determined in a periodic SRS scheduling configuration as described in the diagram 591 of FIG. 5, or may proceed with transmission based on another pre-defined scheme as described in the diagram 592 of FIG. 5. In FIG. 10, the UE3 may transmit, at one burst, an SRS in a frequency domain used by the UE3 in a subframe #3 1013 and a subframe #4 1014 according to a configuration of a periodic SRS as illustrated in the diagram 1060. Also, an SRS may be transmitted in the region identical to a frequency domain used by the UE3 in the subframe #1 1011, based on the repetitive periodic scheduling after the subframe #4 1014.

Unlike Table 2 and Table 3, an implicit method that does not allocate a separate bit may be used for transmitting indication information. The implicit method may transmit indication information together with another information through use of implication so that the indication information may be inferred from the other information, unlike an explicit method that allocates a separate bit. A simple example of the implicit method may include a masking scheme and the like.

The implicit signaling method may include all schemes that transmit information that is implied in another information without using a predetermined bit. As an embodiment of the implicit signaling, the masking scheme may be described as follows. For example, the user equipment may determine indication information by combining cyclic shift (CS) information of a demodulation reference signal (DM-RS) and orthogonal cover code (OCC) information.

For example, when a CS value is received after a signaling that instructs starting of an aperiodic SRS, the user equipment may interpret the corresponding CS value as information associated with a period in which an aperiodic SRS is to be transmitted, and may transmit a control signal. The CS value is merely an example of information that is arranged between the user equipment and the base station for aperiodic transmission of a control signal, and various field values may be applied to the implicit signaling method.

In addition, indication information associated with a period is transmitted through a PDCCH according to an embodiment of the present invention, a user equipment located in a cell boundary has a probability of having a high error rate of a PDCCH and thus, may have difficulty in receiving sequential information. In this example, the error rate may be decreased based on a scheme that increases a coding rate of the PDCCH or repeatition.

In addition, the indication information may be transmitted through use of a channel that has a transmission period less than or equal to a predetermined threshold, a channel having a robustness greater than or equal to a predetermined threshold value, or a channel satisfying both conditions.

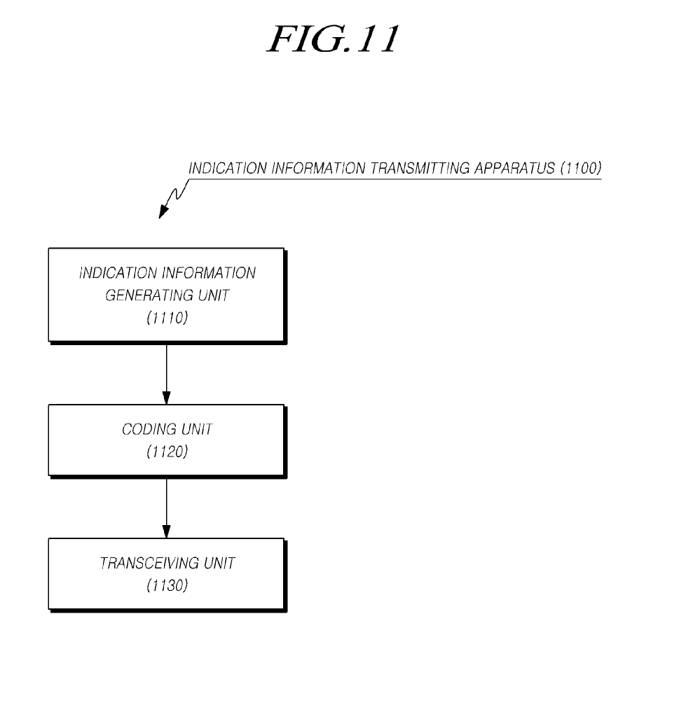

FIG. 11 is a diagram illustrating a configuration of an apparatus for transmitting indication information for aperiodic transmission of a control signal according to an embodiment of the present invention.

The entire configuration may include an indication information generating unit 1110, a coding unit 1120, and a transceiving unit 1130. In particular, the indication information generating unit 1110 may determine a period in which an aperiodic control signal is to be transmitted, and may generate indication information indicating the determined period. The coding unit 1120 may generate a wireless signal including the indication information. The generated wireless signal may be transmitted by the transceiving unit 1130 to a user equipment.

In particular, as described in the foregoing, the indication information may indicate a length of the period in which the periodic control signal is to be transmitted, and may be formed of period indication information and end indication information as described in the embodiment of Table 2. Therefore, the indication information generating unit 1110 may generate one or more pieces of period indication information and at most one piece of end indication information from the length of the period, for example, a time length of the period, and may generate indication information including the one or more pieces of period indication information and the end indication information. At most one piece of end indication information may be generated since the indication information may be formed of only the period indication information without the end indication information. Therefore, as described in the example of FIG. 10, aperiodic transmission of a control signal may be instructed by combining period indication information of 1 bit. The indication information may include N pieces of period indication information, and N bits obtained by extracting 1 bit from each of the N pieces of period indication information and combining the extracted bits may be information required for calculating the length of the period. The aperiodic channel transmission period may be determined by combining 1 bit from each of a plurality of period indication information.

Also, as described in the embodiments of FIGS. 8 and 9, the indication information generating unit 1110 may generate the indication information so that the transceiving unit 1130 may sequentially transmit the period indication information and the end indication information. As one embodiment of this, the indication information may be generated so that the period indication information and the end indication information may be transmitted for each subframe. As described in the foregoing, the indication information may be included in a PDCCH and may be transmitted to the user equipment.

The indication information transmitting apparatus of FIG. 11 may additionally receive a control signal. That is, the transceiving unit 1130 may receive a control signal transmitted by the user equipment based on information associated with a transmission period of an aperiodic control signal. Also, the transceiving unit 1130 may receive a periodic control signal.

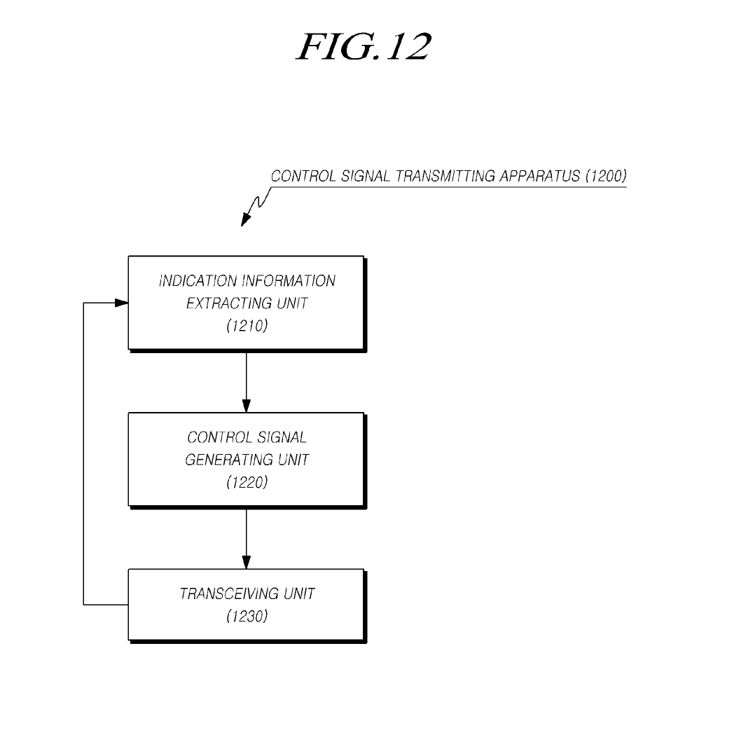

FIG. 12 is a diagram illustrating a configuration of an apparatus for transmitting an aperiodic control signal according to an embodiment of the present invention.

The apparatus of FIG. 12 may include an indication information extracting unit 1210, a control signal generating unit 1220, and a transceiving unit 1230.

In particular, the apparatus of FIG. 12 for transmitting an aperiodic control signal may include the transceiving unit 1230 that receives, from a base station, a wireless signal including indication information indicating a transmission period of an aperiodic control signal, and to transmit a channel estimation signal to the base station, an indication information extracting unit 1210 that extracts the indication information from the wireless signal, and the control signal generating unit 1220 that determines the period in which an aperiodic control signal is to be transmitted based on the indication information, and generate a control signal to be transmitted during the period. An embodiment of the indication information extracted by the indication information extracting unit 1210 in FIG. 12 may be information indicating a length of a period in which an aperiodic control signal is to be transmitted. An embodiment of the control signal generating unit 1220 of FIG. 12 may indicate generating a channel estimation reference signal.

As described in the embodiments of FIGS. 8 and 9, and Table 2, the indication information extracting unit 1210 may extract one or more pieces of period indication information and at most one piece of end indication information from the indication information. The end indication information may not exist since the indication information may be formed of only the period indication information without the end indication information, as described in the case of Table 3. Based on the extracted indication information, the control signal generating unit 1220 may calculate a length of the period based on the one or more pieces of period indication information so as to determine the transmission period of an aperiodic control signal, and the transceiving unit 1230 may transmit an aperiodic control signal during the transmission period.

An embodiment of the indication information extracted by the indication information extracting unit 1210 may be sequentially transmitted from the base station, for each subframe as illustrated in FIGS. 8 and 9. Accordingly, the transceiving unit 1230 according to an embodiment of the present invention may sequentially receive the period indication information and the end indication information. In particular, the transceiving unit 1230 may receive the period indication information or the end indication information included in a PDCCH.

The control signal generating unit 1220 may generate information required for calculating the length of the period based on N bits obtained by extracting 1 bit from each of N pieces of period indication information included in the indication information and combining the extracted bits, as an embodiment of calculating a period required for aperiodic transmission.

Although exemplary embodiments of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method for a base station to control aperiodic transmission of a control signal of a user equipment, the method comprising:
determining a period in which the user equipment is to transmit an aperiodic control signal;
generating one or more pieces of period indication information indicating a time length of the period in which the aperiodic control signal is to be transmitted and one or more pieces of end indication information;
generating indication information including the period indication information and the end indication information, and transmitting the indication information to the user equipment; and
receiving the aperiodic control signal from the user equipment during the determined period.

2. The method as claimed in claim 1, wherein transmitting comprises:
sequentially transmitting the period indication information and the end indication information to the user equipment.

3. The method as claimed in claim 1, wherein the indication information comprises N pieces of period indication information,
wherein N bits obtained by extracting 1 bit from each of the N pieces of period indication information and combining the extracted bits, correspond to information required for calculating the time length of the period.

4. A method of transmitting an aperiodic control signal, the method comprising:
receiving, from a base station, indication information indicating a time length of a transmission period of an aperiodic control signal;
extracting, from the indication information, one or more pieces of period indication information and at most one piece of end indication information;
determining the transmission period of the aperiodic control signal by calculating the time length of the period based on the one or more pieces of period indication information; and
transmitting, to the base station, the aperiodic control signal in the determined transmission period.

5. The method as claimed in claim 4, wherein receiving comprises:
sequentially receiving the period indication information and the end indication information.

6. The method as claimed in claim 4, wherein determining comprises:
generating information required for calculating the time length of the period based on N bits obtained by extracting 1 bit from each of N pieces of period indication information included in the indication information and combining the extracted bits.

7. An apparatus for transmitting indication information for aperiodic transmission of a control signal, the apparatus comprising:
an indication information generating unit to determine a period in which an aperiodic control signal is to be transmitted, and to generate indication information including one or more pieces of period indication information indicating a time length of the determined period and one or more pieces of end indication information;
a coding unit to generate a wireless signal including the indication information; and
a transceiving unit to transmit the wireless signal to a user equipment and to receive the aperiodic control signal during the determined period.

8. The apparatus as claimed in claim 7, wherein the indication information generating unit generates the indication information so that the transceiving unit sequentially transmits the period indication information and the end indication information.

9. The apparatus as claimed in claim 7, wherein the indication information includes N pieces of period indication information,
wherein N bits obtained by extracting 1 bit from each of the N pieces of period indication information and combining the extracted bits, correspond to information required for calculating the time length of the period.

10. An apparatus for transmitting an aperiodic control signal, the apparatus comprising:
a transceiving unit to receive, from a base station, a wireless signal including indication information indicating a transmission period of an aperiodic control signal, and to transmit a channel estimation signal to the base station;
an indication information extracting unit to extract the indication information from the wireless signal, and to extract one or more pieces of period indication information and at most one piece of end indication information from the indication information; and
a control signal generating unit to calculate a time length of the period in which an aperiodic control signal is to be transmitted based on the one or more pieces of period indication information, and to generate an aperiodic control signal to be transmitted during the period.

11. The apparatus as claimed in claim 10, wherein the transceiving unit sequentially receives the period indication information and the end indication information.

12. The apparatus as claimed in claim 10, wherein the control signal generating unit generates information required for calculating the time length of the period based on N bits obtained by extracting 1 bit from each of N pieces of period indication information included in the indication information and combining the extracted bits.
